(19) United States
(12) Patent Application Publication
(10) Pub. No.: US 2025/0305824 A1
(43) Pub. Date: Oct. 2, 2025

(54) METHOD OF CALIBRATION OF A TOTAL STATION AND TOTAL STATION THEREOF

(71) Applicant: Trimble Inc., Westminster, CO (US)

(72) Inventors: Magnus Westermark, Danderyd (SE); Christian Grässer, Danderyd (SE); Mikael Nordenfelt, Danderyd (SE); Jonas Claesson, Danderyd (SE)

(73) Assignee: Trimble Inc., Westminster, CO (US)

(21) Appl. No.: 19/232,669

(22) Filed: Jun. 9, 2025

Related U.S. Application Data
(63) Continuation of application No. PCT/EP2023/050560, filed on Jan. 11, 2023.

(51) Int. Cl. G01C 11/02; G01C 25/00

(52) U.S. Cl. CPC G01C 11/02; G01C 25/00

(57) ABSTRACT

The present disclosure relates to a total station and to method of calibrating a total station (500). The total station comprises a centre unit (510) mounted on an alidade (520) for rotation about a first axis (130), wherein the alidade is mounted on a base (540) of the total station for rotation about a second axis (150) orthogonal to the first axis such that a sighting axis (170) of the total station is rotatable about a rotation point. The centre unit includes a plurality of measurement channels, wherein a measurement channel is associated with a measuring device (512, 514, 518) having an optical axis and wherein at least one measuring device is a camera (512) configured to capture images. The method comprises determining a collimation error relative to the sighting axis for any one of the plurality of measurement channels, thereby providing a calibrated reference measurement channel. The method comprises rotating the centre unit around at least the first axis to a predetermined position at which a collimated calibrating light beam enters the centre unit via an objective of the centre unit for further propagation towards the camera. The collimated calibrating light beam is related to (i) at least one measurement channel to be calibrated if the calibrated reference measurement channel is the measurement channel associated with the camera or (ii) said calibrated reference measurement channel if the calibrated reference measurement channel is a measurement channel other than the measurement channel associated with the camera. The method further comprises capturing at least one image with the camera, wherein the collimated calibrating light beam is detectable in the at least one image, and determining a relative collimation error between the measurement channel associated with the camera and the at least one measurement channel to be calibrated if the calibrated reference measurement channel is the measurement channel associated with the camera, or between the measurement channel associated with the camera and the calibrated reference measurement channel if the calibrated reference channel is a measurement channel other than the measurement channel associated with the camera, based at least on a position of an image point corresponding to the collimated calibrating beam in the at least one captured image.

### CROSS-REFERENCE TO RELATED APPLICATIONS

The present application is a continuation of International Application No. PCT/EP2023/050560, filed Jan. 11, 2023, the contents of which are incorporated herein by reference in their entirety for all purposes.

### TECHNICAL FIELD

The present disclosure relates to the field of surveying equipment and more specifically to a total station and a method of calibration of a total station for surveying applications.

### BACKGROUND

Generally, surveying of e.g., land, buildings and constructions sites, involves the determination of terrestrial (e.g., two-dimensional, 2D, or three-dimensional, 3D) positions of points and/or the determination of distances and angles between these points. In surveying applications, a surveyor may use a surveying instrument, such as a robotic total station integrating an electronic distance measurement unit (EDM unit) with a movable centre unit (or telescope) for rotation about at least two axes (typically a trunnion, or horizontal, axis and an azimuth, or vertical, axis).

The centre unit may typically be mounted on an alidade for rotation about a first axis (e.g., the trunnion axis) and the alidade may be mounted on a base for rotation about a second axis (e.g., the azimuth axis) intersecting (e.g., being orthogonal to) the first axis, such that a sighting axis of the total station is rotatable about a rotation point (typically corresponding to the intersection between the first axis and the second axis).

The base is used for mounting the instrument on the ground, a floor, a wall, or any other object and may include, for example, a tripod. The base defines the first axis about which the alidade is rotatable relative to the base. Typically, when set up for surveying applications, the base is mounted such that the first axis is orientated in the vertical direction (i.e., along a local gravity direction). The alidade defines the second axis about which the centre unit is rotatable relative to the alidade.

The sighting axis (or optical axis) of the total station is defined as an axis of the centre unit that is orthogonal to the first axis, i.e., the axis about which the centre unit is rotatable relative to the alidade. The sighting axis is also the axis along which a measurement is intended to be performed using the centre unit such as, for example, by means of the EDM unit.

For performing such measurements, the total station may also comprise rotational encoders measuring the rotational positions of the alidade about the first axis relative to the base and of the centre unit about the second axis relative to the alidade. It is then possible to determine the orientation of the sighting axis in a coordinate system defined relative to the base such that the measurement performed along the sighting axis can be associated with this coordinate system.

Measurements may be performed by means of a plurality of devices located in the centre unit. These devices include for example the EDM unit for measuring a distance from the total station to a target, a laser pointer for assisting in pointing at a specific target, a reticle for sighting a target (typically via an eyepiece) and one or more cameras for capturing images of a target or a scene surrounding the total station and/or for assisting in tracking of a target. Each of these devices (or measuring devices) may be associated with an optical axis and constitutes a measurement channel within the centre unit in the sense that at least a direction, as defined by the rotational encoders, may be obtained (or measured) by means of such devices.

Ideally, the optical axis associated with each of these devices (or measurement channels) shall be aligned with the sighting axis. However, this may not always be the case due to mechanical imperfections, such as, e.g., the first axis and the second axis not being exactly orthogonal to each other or the sighting axis not being exactly orthogonal to the first axis, and also changes over time due to influence from the environment, such as changing temperatures. There is therefore a need of calibrating the total station, not only in factory but also on-site, in order to determine any collimation error between the sighting axis and the optical axes associated with the plurality of measuring devices of the plurality of measurement channels.

Traditionally, surveyors measure collimation errors of these measurement channels manually. However, such calibration measurements are time consuming, require experience and may thereby be prone to errors.

Hence, it is desirable to provide a new and/or improved method for calibration of a total station and a new and/or improved total station facilitating such calibration.

### SUMMARY

The present disclosure seeks to provide at least some embodiments that overcome at least some of the above-mentioned drawbacks. More specifically, the present disclosure aims at providing at least some embodiments offering at least a less tedious and less time-consuming method for calibration of a total station. To achieve this, a total station and a calibration method having the features as defined in the independent claims are provided. Further advantageous embodiments of the present disclosure are defined in the dependent claims.

Embodiments according to a first aspect of the present disclosure provide a method of calibrating a total station.

The total station comprises a centre unit (or telescope) mounted on an alidade for rotation about a first axis, and the alidade is mounted on a base of the total station for rotation about a second axis orthogonal to the first axis such that a sighting axis of the total station is rotatable about a rotation point. The centre unit includes a plurality of measurement channels, wherein a measurement channel is associated with a measuring device having an optical axis and wherein at least one measuring device is a camera configured to capture images.

The method comprises determining a collimation error relative to the sighting axis for any one of the plurality of measurement channels, thereby providing a calibrated reference measurement channel. The method further comprises rotating the centre unit around at least the first axis to a predetermined position at which a collimated calibrating light beam enters the centre unit via an objective of the centre unit for further propagation towards the camera. The collimated calibrating light beam is related to (i) at least one measurement channel to be calibrated if the calibrated reference measurement channel is the measurement channel associated with the camera or (ii) the calibrated reference measurement channel if the calibrated reference measurement channel is a measurement channel other than the measurement channel associated with the camera.

The method further comprises capturing at least one image with the camera, wherein the collimated calibrating light beam is detectable in said at least one image, and determining a relative collimation error between the measurement channel associated with the camera and the at least one measurement channel to be calibrated if the calibrated reference measurement channel is the measurement channel associated with the camera, or between the measurement channel associated with the camera and the calibrated reference measurement channel if the calibrated reference channel is a measurement channel other than the measurement channel associated with the camera, based at least on a position of an image point corresponding to the collimated calibrating beam in the at least one captured image.

Embodiments according to a second aspect of the present disclosure provide a total station including a centre unit mounted on an alidade for rotation about a first axis and a base on which the alidade is mounted for rotation about a second axis intersecting the first axis such that a sighting axis of the total station is rotatable about a rotation point. The centre unit includes a plurality of measurement channels, wherein a measurement channel is associated with a measuring device having an optical axis and wherein at least one measuring device is a camera configured to capture images.

The total station further includes at least one optical element attached to the alidade or the base, and a processing unit configured to perform a calibration of the total station in accordance with the above disclosed method, i.e., by:
determining a collimation error relative to the sighting axis for any one of the plurality of measurement channels, thereby providing a calibrated reference measurement channel;
causing the rotation of the centre unit around at least the first axis to a predetermined position at which a collimated calibrating light beam emitted at, or reflected against, the optical element enters the centre unit via an objective of the centre unit for further propagation towards the camera, wherein the collimated calibrating light beam is related to (i) at least one measurement channel to be calibrated if the calibrated reference measurement channel is the measurement channel associated with the camera or (ii) the calibrated reference measurement channel if the calibrated reference measurement channel is a measurement channel other than the measurement channel associated with the camera;
causing the capture of at least one image with the camera, wherein the collimated calibrating light beam is detectable in the at least one image; and
determining a relative collimation error between the measurement channel associated with the camera and the at least one measurement channel to be calibrated if the calibrated reference measurement channel is the measurement channel associated with the camera, or between the measurement channel associated with the camera and the calibrated reference measurement channel if the calibrated reference channel is a measurement channel other than the measurement channel associated with the camera, based at least on a position of an image point corresponding to the collimated calibrating beam in the at least one captured image.

The calibration method (or calibration procedure) in accordance with the present embodiments includes the determination of a collimation error relative to the sighting axis for any one of the plurality of measurement channels, thereby providing a calibrated reference measurement channel. This collimation error may be referred to as an absolute collimation error in the sense that the sighting axis, as defined by the angles read to the angular encoders after rotation about the first axis and the second axis, determines the axis along which the measurement is intended to be made. If the optical axis of the measuring device of a measurement channel is aligned with (or coincides with) the sighting axis, then there is no collimation error. The determination of this absolute collimation error for a measurement channel allows for a correction of the measurement performed with the measuring device associated with that measurement channel.

The calibration method in accordance with the present embodiments includes the determination of a relative collimation error between the calibrated reference measurement channel and another measurement channel. An absolute collimation error for the other channel can then be determined based on the determined relative collimation error. As mentioned above, in the present disclosure, the term “absolute collimation error” refers to the collimation error determined relative to the sighting axis of the total station, i.e., relative to the axis along which the measurement is intended to be performed when selecting an angular position of the centre unit relative to the first and second axes. The relative collimation error refers to the collimation error of a measurement channel relative to any measurement channel, but in particular the calibrated reference measurement channel.

The calibrated reference measurement channel may for example be the measurement channel associated with the camera of the total station and, by means of the above-mentioned procedure including the capture of an image in which the collimated calibrating light beam is detectable, a relative collimation error may be determined between the measurement channel associated with the camera and another measurement channel to be calibrated and to which the collimated calibrating light beam is related. The relative collimation error can be determined based on a position of an image point (such as, e.g., a spot) corresponding to the collimated calibrating beam in the captured image. For example, if the image point (or spot) for the collimated calibrating beam deviates from the centre of the image sensor of the camera, then a relative collimation error between the measurement channel of the camera and the measurement channel to be calibrated is obtained.

It will be appreciated that the collimated calibrating light beam may for example be related to the measurement channel to be calibrated in the sense that the collimated calibrating light beam propagates, at least partly, within the measurement channel to be calibrated.

In another example, the calibrated reference measurement channel may be another measurement channel than the measurement channel associated with the camera, such as for instance the measurement channel associated with the EDM unit. The collimated calibrating light beam which is to be detected in the image captured by the camera is then related to the calibrated reference measurement channel, i.e., the measurement channel of the EDM unit in the present example. If the image point (or spot) corresponding to the collimated calibrating light beam corresponds to, for example, the centre of the image sensor of the camera, then there is no relative collimation error between the measurement channel associated with the EDM unit and the measurement channel associated with the camera. In that case, the absolute collimation error for the camera is the same as the absolute collimation error determined for the measurement channel associated with the EDM unit. However, if the image point corresponding to the collimated calibrating light beam deviates from the centre of the image sensor of the camera, then there is a relative collimation error between the measurement channels of the camera and the EDM unit. The absolute collimation error for the measurement channel associated with the camera can then be obtained based on the determined collimation error for the calibrated reference measurement channel and the determined relative collimation error.

It will be appreciated that the position of the image point (or spot) of the collimated calibrating light beam may be compared with the position of another point of the image sensor of the camera than its centre, depending on the arrangement of the camera in the centre unit of the total station and its associated optics. More generally, the determination of the relative collimation error may include a comparison of the position of the image point with the position of a reference point (in the image captured by a camera) representative of the optical axis (or measurement axis) associated with the camera.

In the present embodiments, the determination of the relative collimation error between two measurement channels involves the capture of an image. Therefore, at least one of the measurement channels involved in the method according to the present embodiment is a measurement channel associated with a camera of the total station. However, as mentioned above, the measurement channel associated with the camera may either be the calibrated reference measurement channel or the measurement channel to be calibrated.

If the calibrated reference measurement channel is the measurement channel associated with the camera, the measurement channel to be calibrated, i.e., the measurement for which a relative collimation error is to be determined, may be either one of the other measurement channels. If the calibrated reference measurement channel is a measurement channel other than the measurement channel associated with the camera, the measurement channel to be calibrated, i.e., the measurement for which a relative collimation error is to be determined, is the measurement channel associated with the camera.

In some embodiments, the determination of the relative collimation error may be performed for several of the remaining measurement channels.

The present embodiments are beneficial in that it only requires the determination of an absolute collimation error (i.e., a determination of the collimation error between the optical axis of a measuring device and the sighting axis of the total station) for one of the plurality of measurement channels. The other measurement channels can be calibrated using the above-described procedure based on the (absolute) collimation error determined for the calibrated reference measurement channel and an image of a collimated calibrated light beam captured by the camera.

Further, the calibration procedure for the remaining measurement channels may be performed using a collimated calibrating light beam which enters the centre unit when it is rotated at a predetermined position. In other words, the remaining measurement channels (i.e., the measurement channels other than the calibrated reference measurement channel) can be calibrated without requiring the surveyor to sight at, e.g., an external object. The calibration of the remaining measurement channels can therefore be performed automatically by causing the centre unit to rotate to the predetermined position and by performing the above-mentioned procedure (including the capture of the collimated calibrating light beam in an image captured by the camera and the determination of the relative collimation error based on the collimation error determined for the calibrated reference measurement channel) and the captured image.

As mentioned above, the centre unit may be rotated to a predetermined position at which a collimated calibrating light beam enters the centre unit via an objective of the centre unit for further propagation towards the camera. As will be explained in more detail in the following, the calibrating light beam may originate from a light source being located within the centre unit of the total station or from a light source external to the centre unit, for example a light source located at the alidade of the total station or even, in some implementations, external to the total station. In any case, the collimated calibrating light beam enters (or re-enters) the centre unit for further propagation towards the camera. It will be appreciated that a calibrating light beam originating from a light source being located within the centre unit (or a calibrating light beam passing through the centre unit) becomes collimated when exiting the centre unit at least by means of the objective (or front lens) of the centre unit.

An optical element, such as for example a retroreflector or a light source itself, may be arranged such that the collimated calibrating light beam, either reflected at the retroreflector or emitted by the light source, enters the centre unit when the centre unit is rotated to the predetermined position. Different implementations of such an optical element will be described in more detail in the following.

It will be appreciated that the optical axis of the measuring device for a measurement channel may also be referred to as a measuring axis for that measurement channel.

The predetermined position of the centre unit corresponds to an angular rotation of the centre unit relative to the first axis. The centre unit may have any angular rotation relative to the second axis for the determination of the relative collimation error.

According to some embodiments, the determination of the collimation error of the reference measurement channel relative to the sighting axis of the total station includes sighting the centre unit towards a far-field object. In some embodiments, the determination of the collimation error of the reference measurement channel relative to the sighting axis of the total station includes performing a first measurement in a first face of the total station and a second measurement in a second face of the total station, wherein, in the second face, the centre unit is rotated around each one of the first axis and the second axis of the total station by 180° compared to the first face. In other words, the determination of the absolute collimation error for the calibrated reference measurement channel may involve a face 1/face 2 (F1/F2) calibration which includes sighting of a far-field object by the surveyor. However, it will be appreciated that the determination of the absolute collimation error for a measurement channel may be performed by other methods.

Further, the camera used for capturing the image may be either one of a camera configured for capturing images of a scene surrounding the total station or a camera configured for tracking of a target by the total station.

According to an embodiment, the calibration method may be performed for obtaining a relative collimation error between the measurement channel associated with the camera and a measurement channel associated with a measuring device including a light source. The measuring device may for example be an EDM unit, which typically includes a light source acting as a transmitter to emit a light beam towards a target and a photodetector acting as a receiver to detect a light beam reflected at the target. The measuring device may however be any measuring device including a light source such as for example a laser pointer or the like that can emit the calibrating light beam.

Accordingly, in the present embodiment, the at least one measurement channel to be calibrated if the calibrated reference measurement channel is the measurement channel associated with the camera, or the calibrated reference measurement channel if the calibrated reference measurement channel is a measurement channel other than the measurement channel associated with the camera, includes a measurement channel associated with a measuring device including a light source. The collimated calibrating light beam originates from the light source and (re) enters the centre unit by retroreflection against an optical element attached to the alidade or the base of the total station.

In other words, in the present embodiment, a calibrating light beam is generated by a light source located within the centre unit. The calibrating light beam exits from the centre unit via the objective of the centre unit, thereby becoming a collimated calibrating light beam, and is then reflected back into the centre unit by retroreflection against the optical element attached to, e.g., the alidade or the base. The optical element may be a retroreflector, i.e., an optical element or device that reflects the collimated light beam so that the paths of the reflected light beam are parallel to those of the incident collimated light beam.

According to another embodiment, the calibration method may be performed for obtaining a relative collimation error between the measurement channel associated with the camera and a measurement channel associated with another camera of the centre unit of the total station. It will be appreciated that the total station may include several cameras for different functions such as one camera for imaging the surrounding of the total station and another camera dedicated for tracking of a target. The two cameras may be located at different positions within the centre unit of the total station.

Accordingly, in the present embodiment, the camera referred to in the above-mentioned procedure may be referred to as a first camera configured to capture images within a first wavelength range. Further, the at least one measurement channel to be calibrated if the calibrated reference measurement channel is the measurement channel associated with the first camera, or the calibrated reference measurement channel if the calibrated reference measurement channel is a measurement channel other than the measurement channel associated with the first camera, includes a measurement channel associated with a second camera configured to capture images within a second wavelength range. The collimated calibrating light beam includes light of a first wavelength within the first wavelength range and light of a second wavelength within the second wavelength range. The method may then further comprise capturing at least one image of the collimated calibrating light beam with the second camera. Hence, in the present embodiment, a first image, in which the collimated calibrating light beam is detectable, is captured by the first camera and a second image, in which the collimated calibrating light beam is also detectable, is captured by the second camera. The relative collimation error may then be determined by a comparison between the position of the image point corresponding to the collimated calibrating light beam in the image captured by the first camera and a position of an image point corresponding to the collimated calibrating light beam in the image captured by the second camera. It will be appreciated that several images may be taken by each one of the two cameras for improved accuracy.

In some embodiments, the first wavelength is the same as the second wavelength. In other words, the first and second cameras may be configured to detect light of a same wavelength, e.g. originating from the same light source.

Further, in some embodiments, the first wavelength range is the same as the second wavelength range. The two cameras may therefore be sensitive in the same wavelength range.

In some embodiments, the collimated calibrating light beam may originate from a light source of a measuring device of the plurality of measuring devices and enter the centre unit by retroreflection against an optical element attached to the alidade or the base of the total station.

For example, the collimated calibrating light beam may originate from the light source (laser source) of the EDM unit (the light beam becoming collimated when exiting the centre unit via the objective of the centre unit). The collimated calibrating light beam may be directed to an optical element, such as a retroreflector, arranged at the alidade or the base of the total station and reflected back in the centre unit, via the objective of the centre unit, for further propagation to each one of the two cameras. An optical path may therefore be provided within the centre unit for each of the two cameras in that the collimated calibrating light beam is detectable at the first camera and at the second camera.

Hence, it will be appreciated that several measurement channels may be calibrated at one predetermined position of the centre unit relative to the first axis, as defined by an angular position of the centre unit. In the present example, assuming that the calibrated reference measurement channel is the measurement channel associated with the first camera, a relative collimation error can be determined between the measurement channel associated with the first camera and the measurement channel associated with the EDM unit by identifying the position of the image point in the image captured by the first camera (for example by determining that the image point is not centred in the middle of the image sensor of the camera) and another relative collimation error can be determined between the measurement channel associated with the first camera and the measurement channel associated with the second camera by comparing the positions of the image points corresponding to the collimated calibrating light beam in the image captured by the first camera and in the image captured by the second camera.

In some embodiments, the calibrating light beam may originate from a light beam entering the centre unit via an eyepiece of the total station (or via the measurement channel associated with the reticle of the centre unit of the total station, which typically corresponds to the measurement channel associated with the eyepiece) and propagating towards an optical element attached to the alidade or the base of the total station before entering again the centre unit (via the objective) by retroreflection against the optical element. This embodiment is in principle equivalent to the embodiment described above except that the calibrating light beam does not originate from a light source located within the centre unit but from an external light source located outside the centre unit or the total station. In this embodiment, as the calibrating light beam enters via the eyepiece of the centre unit, it will be subject to, and thereby collimated by, the front lens the centre unit. Hence, the light beam originating from this light source does not need to be collimated. However, as mentioned above, when the light is reflected back at the retroreflector to (re)-enter the centre unit, the light beam is collimated.

Still referring to a procedure in which the determination of the relative collimation error is performed between two cameras, in some embodiments, the first wavelength may be different from the second wavelength. For example, the first wavelength may be in the visible wavelength range, which may typically correspond to the sensitivity of a camera configured for capturing images of the surrounding of the total station, and the second wavelength may be in the range of 800-900 nm, which may typically correspond to the sensitivity of a camera configured for tracking of a target. It will be appreciated that the collimated calibrating light beam may include light having two (or more) different wavelengths.

As another alternative for providing the collimated calibrating light beam, a light source may be attached to the alidade or the base of the total station. The light source may be positioned, and/or a light path may be provided from the light source, such that the light beam can enter the centre unit via the objective of the total station when the centre unit is rotated to the predetermined position. In one example, the light beam may be provided by a light source placed behind a pinhole or an arrangement such as a negative crosshair/reticle such that the light beam emitted from the pinhole, or this arrangement, is collimated. The light source may include a first light emitting element (or first light source) configured to emit light at a first wavelength within the first wavelength range and a second light emitting element (or second light source) configured to emit light at a second wavelength within the second wavelength range. From the perspective of the first and second cameras, the first and second light emitting elements (or the first and second light sources) are arranged to emit light from a same optical position.

Further, as for the case in which the first wavelength and the second wavelength are the same, the collimated calibrating light beam may originate from a light beam entering the centre unit via an eyepiece of the total station and propagating towards an optical element attached to the alidade or the base of the total station before entering again the centre unit by retroreflection against the optical element. The light beam entering the centre unit via the eyepiece does not need to be collimated as it will be collimated by the optics located in the centre unit (and more specifically the front lens of the centre unit). The light beam may originate from a light source emitting at two different wavelengths.

In another embodiment, the calibration method may be performed for obtaining a relative collimation error between the measurement channel associated with the camera and a measurement channel associated with a reticle of the centre unit of the total station. The reticle may be arranged in front of, or close to, an eyepiece of the centre unit.

Accordingly, in this embodiment, the measurement channel to be calibrated if the calibrated reference measurement channel is the measurement channel associated with the camera, or the calibrated reference measurement channel if the calibrated reference measurement channel is a measurement channel other than the measurement channel associated with the camera, includes a measurement channel associated with the reticle of the centre unit. The collimated calibrating light beam may originate from a light beam entering the centre unit via the measurement channel associated with the reticle (which typically corresponds to the eyepiece) of the centre unit and propagating towards an optical element attached to the alidade or the base of the total station before entering again the centre unit by retroreflection against the optical element, for propagation towards the camera. In the present embodiment, the light source will illuminate the reticle and thereby project an image of the illuminated reticle. The reticle may be a positive haircross (so that the reticle will cast a shadow) or a negative haircross. The image captured by the camera will contain an image of the reticle. The image point corresponding to the collimated calibrating light beam will correspond to the center of the imaged reticle.

As for the preceding embodiments in which the light beam originates from a light source placed at the eyepiece of the centre unit of the total station, the light beam does not need to be collimated before entering the centre unit via the eyepiece. However, the light beam will be collimated by the centre unit and still remain collimated when being reflected back at the retroreflector for being directed towards the camera.

In embodiments in which the light beam originates from a light source arranged at the eyepiece of the centre unit of the total station, the light source may be provided in a protection bag of the total station or at a fixed position such as, e.g., a wall or a ceiling for production testing such that the light from the light source can enter the centre unit when the instrument is rotated at the predetermined position. In some embodiments, the light source may be external to the centre unit but still placed at an element of the total station such as, for example, an handle of the total station provided at the alidade.

As mentioned above, the centre unit is rotated to a predetermined position such that the collimated calibrating light beam enters the centre unit for further propagation towards the camera. In some embodiments, several measurement channels may be calibrated from a single predetermined position, for example using the light source of a measuring device of the centre unit for determining both the relative collimation error between the measurement channel associated with the camera and the measurement channel associated with the measuring device having the light source and the relative collimation error between the measurement channel associated with the camera and a measurement channel associated with another camera (provided that the collimated calibrating light beam originating from the light source of the measuring device is detectable in images captured by both cameras).

In other embodiments, the centre unit may need to be rotated to two or more predetermined positions in order to perform the relative calibration between the measurement channel associated with the camera and other measurement channels. Accordingly, in such embodiments, for performing a relative calibration between a measurement channel associated with another measuring device and the measurement channel associated with the camera, the method further comprises rotating the centre unit around at least the first axis to another predetermined position at which another collimated calibrating light beam enters the centre unit via the objective for further propagation towards the camera. The other collimated calibrating light beam is related to the measurement channel associated with the other measuring device and the method comprises the capture of at least one additional image with the camera, wherein the other collimated calibrating light beam is detectable in said at least one additional image. The method then comprises the determination of a relative collimation error between the measurement channel associated with the camera and the measurement channel associated with the other measuring device based at least on a position of an image point corresponding to the other collimated calibrating beam in said at least one additional image.

The total station may for example include a first optical element attached to the alidade or the base for providing a first collimated calibrating light beam with the centre unit rotated in the predetermined position and a second optical element attached to the alidade or the base for providing a second collimated calibrating light beam with the centre unit rotated in the other predetermined position.

The at least one optical element may include a retroreflector against which light emitted from a light source of a measuring device of the plurality of measuring devices is reflected (back to the centre unit) when the centre unit is rotated in a first predetermined position and/or a light source for emission of a collimated calibrating light beam having a first wavelength and a second wavelength.

The control unit of the total station as described above in relation to the first aspect may be configured to perform a method as defined in any one of the embodiments described herein.

The present disclosure relates to all possible combinations of features recited in the claims and in the preceding embodiments. Further objects and advantages of the various embodiments of the present disclosure will be described below by means of exemplifying embodiments.

### BRIEF DESCRIPTION OF THE DRAWINGS

One or more embodiments will be described, by way of example only, and with reference to the following figures (which should not be considered as being to scale), in which:

FIGS. 1A, 1B and 1C schematically illustrate collimation errors of a total station;

FIG. 2 schematically illustrates a plurality of measurement channels in the centre unit of a total station;

FIGS. 3A, 3B and 4 illustrate the determination of a collimation error relative to the sighting axis of the total station for a measurement channel of the total station;

FIGS. 5A and 5B illustrate the determination of a relative collimation error between a measurement channel associated with the camera and another measurement channel associated with a measuring device including a light source;

FIG. 6 schematically shows an image captured by the camera for determining a relative collimation error;

FIG. 7 illustrates the general outlines of a method of calibrating a total station;

FIGS. 8A-8C illustrates the determination of a relative collimation error between a measurement channel associated with a first camera and a measurement channel associated with a second camera using an external light source;

FIG. 9 illustrates the determination of a relative collimation error between a measurement channel associated with a first camera and a measurement channel associated with a second camera using a light source of a measuring device of the centre unit;

FIG. 10 illustrates the determination of a relative collimation error between a measurement channel associated with a first camera and a measurement channel associated with the reticle of the centre unit of the total station; and

FIG. 11 illustrates the determination of relative collimation errors between several measurement channels of the centre unit of a total station using two or more calibrating light beams.

Whilst the invention is susceptible to various modifications and alternative forms, specific embodiments are shown by way of example in the drawings as herein described in detail. It should be understood, however, that the detailed description herein and the drawings attached hereto are not intended to limit the invention to the particular form disclosed. Rather, the intention is to cover all modifications, equivalents, and alternatives falling within the scope of the appended claims.

As used in this specification, the words “comprise”, “comprising”, and similar words are not to be interpreted in the exclusive or exhaustive sense. In other words, they are intended to mean “including, but not limited to”.

### DETAILED DESCRIPTION

The present invention is described in the following by way of a number of illustrative examples. It will be appreciated that these examples are provided for illustration and explanation only and are not intended to be limiting on the scope of the present invention. Instead, the scope of the present invention is to be defined by the appended claims. Furthermore, although the examples may be presented in the form of individual embodiments, it will be recognised that the invention also covers combinations of the embodiments described herein.

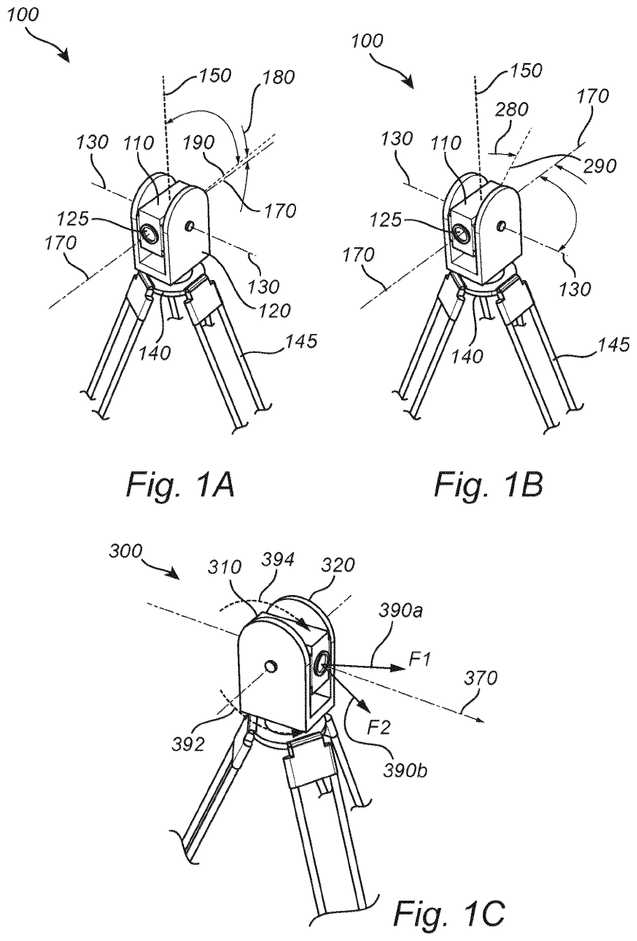

FIGS. 1A to 1B are schematic illustrations of an exemplary total station 100 wherein FIG. 1A illustrates a vertical axis error (or vertical index error) of the total station while FIG. 1B illustrates a horizontal axis error of the total station. The total station 100 may also be referred to as a theodolite.

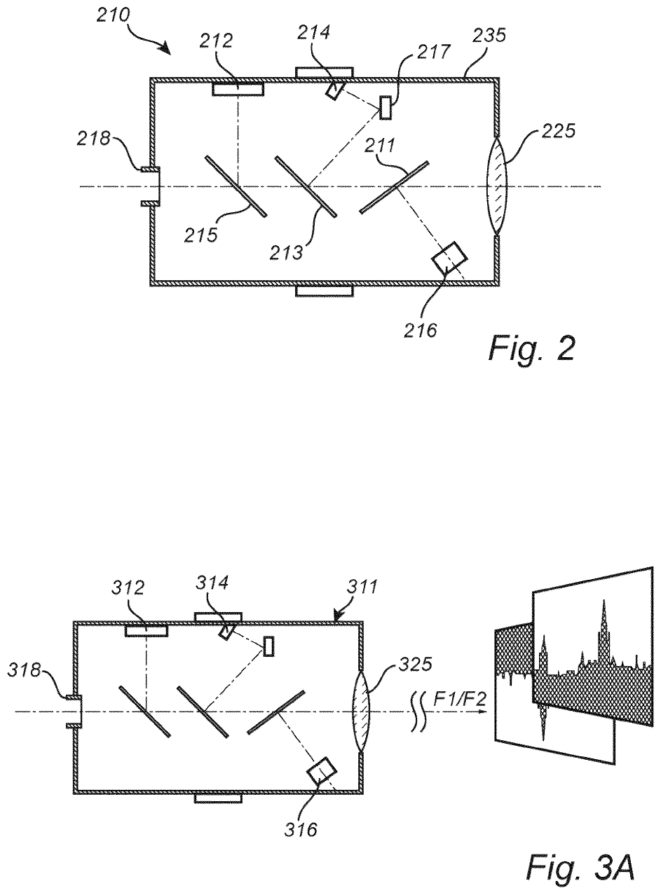

The total station 100 comprises a centre unit 110 mounted on an alidade 120 for rotation about a first axis 130, wherein the alidade 120 is mounted on a base 140 of the total station 100 for rotation about a second axis 150 orthogonal to the first axis 130 and intersecting the first axis 130 such that a sighting axis 170 of the total station is rotatable about a rotation point (not shown but the first and second axes intersect within the centre unit). The centre unit 120 includes a plurality of measurement channels, which will be described with reference to FIG. 2.

The base 140 may include a tripod 145, and the alidade 120 is rotatable relative to the base 140 about the second axis 150. In most surveying scenarios, it is desired that the second axis 150 is orientated vertically and the tripod and tribrach 145 are used to adjust the orientation of the base 140 such that the second axis 150 is parallel to the vertical direction defined by the gravity vector at the location of the total station 100. The centre unit (or telescope) 110 is mounted on the alidade 120 such that it is rotatable relative to the alidade 120 about the first axis 130. The illustrated total station is designed such that the first axis 130 is orientated orthogonally to the second axis 150 and such that the first axis 130 intersects the second axis 150. The total station 100 also includes an objective (or front optics or front lens) 125 at which light may both exit or enter the centre unit 110.

The centre unit 110 or telescope may include a plurality of measurement channels as provided by a plurality of measuring devices of the centre unit. Each of the measurement channel is associated with a measuring device having an optical axis along which a measurement may be performed. For the sake of clarity, only one optical axis (or measuring axis) 190 is shown in FIGS. 1A and 1B. At least one measuring device of the centre unit is a camera configured to capture images, as will be further described in connection to FIG. 2.

For example, the measuring axis 190 can be indicated by a reticle in the visual field of the telescope, and the user can direct the measuring axis 190 to an object of interest in the visual field of the telescope by rotating the centre unit 110 about the second axis 130 and the alidade 120 about the second axis 150. The orientations about the first and second axes 130, 150 may be determined by reading scales provided on the total station, or electronic signals generated by encoders associated with the first and second axes 130, 150 in the total station 100. Based on these readings, an angular position of the object of interest can be determined relative to a coordinate system associated with the base 140. The calculation of this orientation depends on the readings of the rotational positions about the first and second axes 130, 150 as inputs. The calculation further depends on assumptions on the geometry of the total station 100. The assumptions on the geometry include the orientations of the first axis, the second axis and the optical axis (or measuring axis) of the measuring device associated with the measurement channel, relative to each other. If the configuration of the total station deviates from these assumptions, the sighting axis, as determined by the rotation of the centre unit about the first axis 130 and the second axis 150 (and thereby corresponding to the readings on the encoders or scales of the total station), may deviate from the optical axis (or measuring axis) associated with the measurement channel. This will in turn result in an inaccurate calculation of the orientation of the optical axis (or measuring axis) associated with the measurement channel in the coordinate system. The sighting axis may also be referred to as a reference axis in that it is the axis along which the measurement is intended to be performed.

FIG. 1A illustrates one type of collimation error, referred to as the vertical index error (or vertical collimation error). The vertical index error is indicative of an angle 180 between the sighting axis 170 and a measuring axis (or optical axis of a measuring device) 190 of the total station. The sighting axis 170 corresponds to the axis which is exactly orthogonal to the second axis 150 when the centre unit 110 is orientated relative to the alidade 120 such that the angle between the second axis 150 and the sighting axis 170 should be 90° according to a scale provided on the total station or the readings of the encoder associated with the rotation of the centre unit 110 about the first axis 130, assuming that the reading of the encoder or scale is at 0° when the centre unit is orientated such that the sighting axis 170 is orientated upwards, pointing to the zenith, or more generally such that the sighting axis 170 is parallel with the second axis 150. In other words, the sighting axis 170 corresponds to a position in which the angle of rotation of the centre unit about the first axis 130 is 90° (with 0° corresponding to the sighting axis 170 being parallel with the second axis 150). As illustrated in FIG. 1A, the optical axis 190 associated with a measuring device of the centre unit may deviate from the sighting axis 170 by a vertical collimation error 180.

FIG. 1B illustrates a similar type of error which is referred to as the (horizontal) collimation error. This horizontal collimation error is indicative of an angle 280 between an optical axis 290 of a measuring device associated with a measurement channel of the centre unit 110 and the sighting axis 170 while the total station should be set such that the sighting axis 170 is orthogonal to the first axis 130. It will be appreciated that all other elements of the total station 100 shown in FIG. 1B are identical to the elements of the total station 100 described with reference to FIG. 1A.

Hence, an optical axis (or measurement axis) of a measuring device associated with a measurement channel of the centre unit 110 may deviate from the sighting axis 170 by a vertical collimation error and/or a horizontal collimation error. In the following, reference will generally be made to a collimation error which may include a horizontal component and a vertical component.

FIG. 1C illustrates a total station 300 which is identical to the total station 100 described with reference to FIGS. 1A and 1B. The total station 300 includes a centre unit 310 rotatably mounted on an alidade 320, itself rotatably mounted on a base (as shown in FIGS. 1A and 1B). FIG. 1C shows a sighting axis 370 as determined by the rotation of the centre unit about the first and second axes (not shown in FIG. 1C). In the present example, the sighting axis 370 is positioned to be orthogonal to the first and second axes. FIG. 1C also illustrates an optical axis 390a of a measuring device associated with a measurement channel of the centre unit 310 in a first face (i.e., with the centre unit being oriented in a first direction, as determined by the rotation about the first and second axes) and the optical axis 390b of the same measuring device associated with the same measurement channel in a second face, in which the centre unit 310 is rotated around each one of the first axis and the second axis of the total station by 180° compared to the first face, as indicated by the dashed arrows 392 and 394.

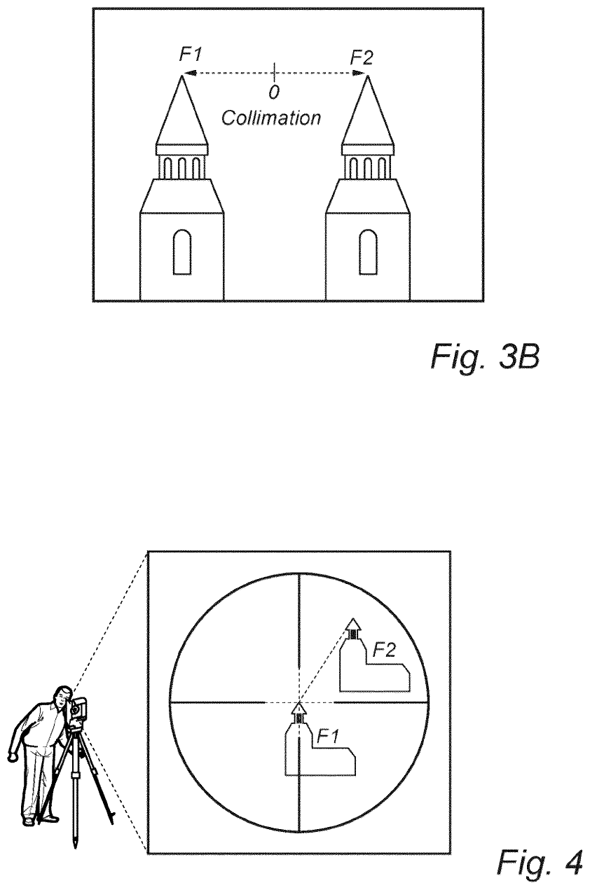

As will be further illustrated with reference to FIGS. 3A, 3B and 4, the collimation error of a measurement channel relative to the sighting axis of the total station may be obtained by performing a first measurement in a first face (F1) of the total station and a second measurement in a second face (F2) of the total station. Without any collimation error, the optical axes 390a and 390b would coincide. However, as illustrated in FIG. 1C, in the presence of a collimation error, the optical axes 390a and 390b point in different directions.

With reference to FIG. 2, the centre unit of a total station according to some embodiments is described.

FIG. 2 is a schematic illustration of a centre unit including a plurality of measurement channels. FIG. 2 shows the inside of a centre unit 210 such as the centre units 110 and 310 described with reference to FIGS. 1A-1C.

The centre unit 210 includes a housing 235 with an eyepiece 218 at one extremity and an objective (or front lens) 225 at an opposite extremity of the housing 235. The centre unit 210 includes a plurality of measuring devices, or devices assisting a surveyor in performing measurements, such as for example an EDM unit 214, a first camera 212 for capturing images of a scene or surrounding of the centre unit 210, a second camera 216 for tracking of a target and a reticle arranged in front of, or along the optical path provided by, the eyepiece 218. In the following, the reticle and the eyepiece will commonly be denoted by reference number 218. As illustrated in FIG. 2, the centre unit also includes a plurality of other optical elements such as splitters, mirrors or the like (e.g., lenses or filters) in order to provide optical paths between the objective 225 of the centre unit 210 and each one of the measuring devices 212, 214, 216 and 218, thereby providing a plurality of measurement channels within the centre unit 210.

For example, optical paths may be established within the centre unit 210 for light arriving via the objective 225 by means of a first splitter 211 redirecting light of a first wavelength (or first wavelength range) towards the second (tracker) camera 216, a second splitter 213 redirecting light of a second wavelength (or second wavelength range) towards the EDM unit 214 via a mirror 217, and a third splitter 215 redirecting light of another wavelength range towards the first camera 212. The reticle 218 may be aligned with the optical axis of the objective 225. As explained with reference to FIGS. 1A-1C, it will be appreciated that the reticle 218, and similarly any optical axis of the EDM unit 214, the first camera 212 and the second camera 216 may deviate from a sighting axis of the centre unit as determined by the angles of rotation of the centre unit about the first and second axes.

Although four example measuring devices are shown in FIG. 2, the centre unit may include more or less than four measuring devices. For example, the centre unit may also include a laser pointer. Further, the optical arrangement and position of the measuring devices shown in FIG. 2 are only for illustration purposes and therefore schematic. The measuring devices may be arranged differently and further optical elements (such as filters) may be added to provide the different optical paths and thus measurement channels.

FIGS. 3A and 3B illustrate the determination of a collimation error relative to the sighting axis of the total station for a measurement channel, and more specifically for the measurement channel associated with a camera, of the total station.

FIG. 3A shows the optical arrangement of a plurality of measuring devices of a centre unit 311 which may be equivalent to the centre units 110, 310 and 210 described with reference to the embodiments shown in the preceding figures.

FIG. 3A also shows the optical paths from the EDM unit 314, the first camera 312, the second camera 316 and the reticle, arranged in proximity to the eyepiece 318, to the objective (or front lens) 325 of the centre unit 311. In the present example, the centre unit 310 is rotated such that an image of part of a town including a church tower can be captured. As already mentioned above in relation to FIG. 1C, a first image may be captured in a first face (also referred to as F1) and a second image may be captured in a second face (also referred to as F2), wherein, in the second face, the centre unit is rotated around each one of the first axis and the second axis of the total station by 180° compared to the first face.

FIG. 3B shows the superposition of the two images captured by, e.g., the camera 312 in the first face and the second face. As can be seen, the position of the church tower in the image captured in the first face deviates from the position of the church tower in the image captured in the second face, thereby indicating a deviation (or misalignment) of the optical axis of the camera relative to the sighting axis of the centre unit. This deviation is therefore indicative of the collimation error of the optical axis of the camera relative to the sighting axis.

In FIG. 3B, the value “0” indicates the position at which the top of the church tower should be placed for the optical axis of the camera to be collimated (i.e., to correspond to the sighting axis). In the present example, the optical axis of the camera appears to be subject to a horizontal collimation error, which can be determined based on the determination of half of the distance between two identical image points of the church tower (e.g., the top of the church tower as shown in FIG. 3A).

Accordingly, a determination of the absolute collimation error of the

measurement channel associated with the camera 312 can be obtained using this procedure. Although the example of FIGS. 3A and 3B illustrate the determination of an absolute collimation error for the measurement channel of the centre unit associated with a first camera, the same procedure may be used for determining the absolute collimation error of other measurement channels.

FIG. 4 illustrates for example the determination of an absolute collimation error for the reticle of the centre unit. As mentioned above, the procedure is in principle identical to the procedure described above for the camera in that a surveyor (or operator of the total station) may look in the eyepiece and places the reticle (or crosshair) seen in the eyepiece on, e.g., the top of the church tower. The operator may then rotate (or may initiate/cause the rotation of) the alidade and the centre unit with 180 degrees around the first axis and the second axis (i.e., the trunnion axis and the vertical axis, respectively) and then again observe in the eyepiece. If the reticle is properly collimated (i.e., no collimation error with respect to the sighting axis), the centre of the reticle (or crosshair) is still at the top of the church tower. If the top of the church tower is displaced relative to the centre of the crosshair, then there is a collimation error, which may be determined based on the vector between the top of the church tower and the origin as represented by the centre of the crosshair.

The same procedure is applicable for the EDM unit and for the second camera used for tracking of a target. In the latter case, the total station may be operated to be locked on a fixed target in a first face and the centre unit may be operated in a second face to be locked on the same target. If the centre unit is rotated by exactly 180° around the first axis and the second axis, then there is no collimation error. However, if the centre unit needs to be rotated by for example 180.2° around one of the axes, the collimation error relative to this axis is then 0.1°.

In principle, this procedure may be performed for all measuring devices, i.e., for all measurement channels, of the centre unit in order to obtain a calibration of all measurement channels relative to the sighting axis of the centre unit of the total station. However, this procedure is time consuming and requires sighting against a far field object.

With reference to the following figures, embodiments of an improved method for calibration of the measurement channels of a total station are described. These embodiments do not require the determination of the absolute collimation error for each one the plurality of measurements channels of the total station.

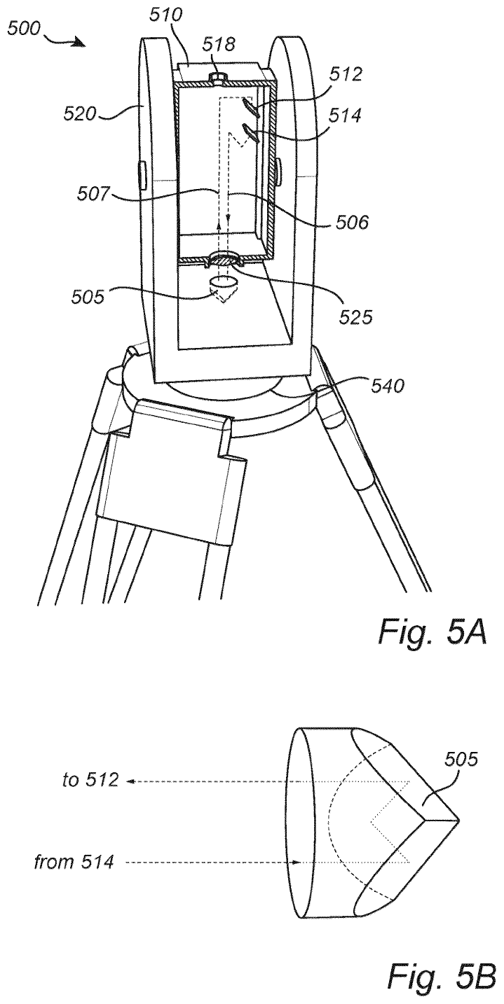

FIG. 5A illustrate the determination of a relative collimation error between a measurement channel associated with the camera and another measurement channel, such as for example the measurement channel associated with the EDM unit.

FIG. 5A shows a total station 500 including a centre unit 510 rotatably mounted on an alidade 520 of the total station 500. The alidade 510 may be rotatably mounted on a base 540 of the total station 500. As shown in FIG. 5A, for the determination of the relative collimation error between the measurement channel associated with the camera 512 and the measurement channel associated with the EDM unit 514, the centre unit is rotated to a predetermined position, which, in the present example, corresponds to the centre unit being turned downwards with the objective 525 of the centre unit being placed in front of an optical element 505, being in the present embodiment a retroreflector or prism. In other words, with the reading of the encoder of the total station or scale being at 0° when the centre unit is orientated such that the sighting axis is orientated upwards, pointing to the zenith, the centre unit of the total station is rotated by 180° about the first axis 130 to point towards (opposite to the zenith). It will be appreciated that this particular angle of rotation is only provided as an example and that the predetermined position may require a different angle of rotation, depending on where the optical element 505 is located on the alidade or base of the total station. It will also be appreciated that this procedure is a different procedure than the above-described face 1/face 2 (F1/F2) procedure for determining the absolute collimation error of one of the measurement channels. Further, this predetermined position may be preconfigured such that a processing unit of the total station is configured to cause the rotation of the centre unit about the first axis in order to automatically reach the predetermined position for the purpose of performing the calibration.

As illustrated in FIG. 5A, in this position, a collimated calibrating light beam 507 enters the centre unit 510 via the objective 525 and propagates towards the camera 512. In the present case, the collimated calibrating light beam originates from a light source (or transmitter) of the EDM unit 512. In other words, the EDM unit 512 emits a light beam 506 towards the objective 525 of the centre unit and becomes collimated when passing the objective 525. The collimated light beam 506 is reflected against the retroreflector 505 arranged at (or attached to) the alidade 520 and it re-enters the centre unit 510 via the objective 525 for further propagation to the camera 512. It will be appreciated that the retroreflector 505 may be arranged at other positions of the alidade and that, in some embodiments, it may be attached to the base 540 or another part of the total station, provided that there is a light path, or rather a line of sight, between the retroreflector 505 and the objective 525 of the total station 500.

FIG. 5B illustrates in more detail an example of a retroreflector, which is an optical component that reflects the collimated light beam so that the paths of the reflected light beam are parallel to those of the incident collimated light beam. As can be seen, the light beam originating from the EDM unit 514 is reflected at the optical element 505 to propagate towards the camera 512 of the total station 500 with a beam parallel with the originating light beam.

An image may then be captured by the camera 512. The above procedure may be performed for different measurement channels of the centre unit, either for the same predetermined position of the centre unit or for different predetermined positions, as will be further illustrated below, and one or more images may be captured by the camera 512.

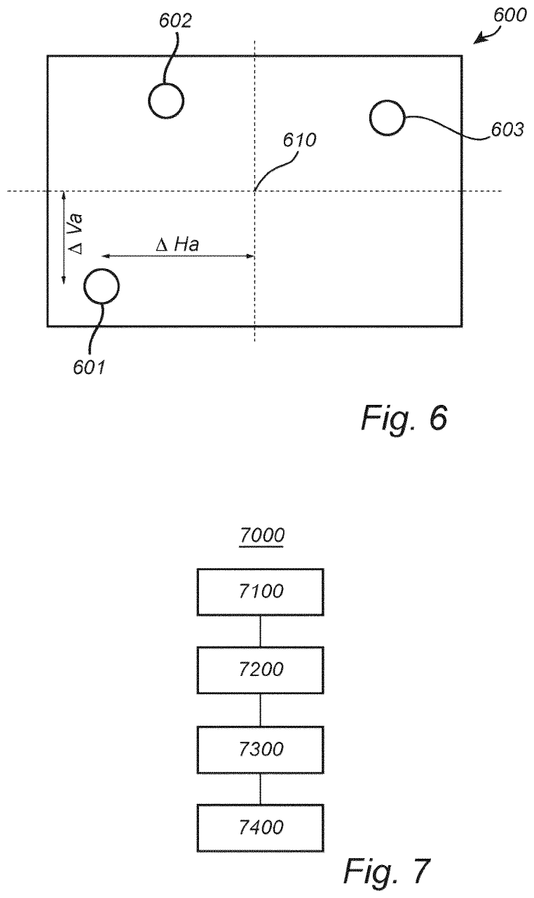

An example of an image captured by the camera 512 is shown in FIG. 6, wherein image points or spots representative of the collimated calibrating light beam for a plurality of channels are illustrated.

FIG. 6 shows an image 600 wherein a first spot 601 may correspond to the image point of the collimated calibrating light beam 507 related to the measurement channel associated with the EDM unit 514, as for example described with reference to FIG. 5. The image 600 may also include other image points 602 and 603, representative of other measurement channels.

A relative collimation error between the measurement channel associated with the camera 512 and the measurement channel associated with the EDM unit 514 can then be determined based on the position of the image point 601 in the image 600. In particular, the vector between the origin 610 of the axes represented in FIG. 6 (which may correspond to a centre of the image sensor of the camera or, alternatively, the coordinates of the sighting axis derived from an external F1/F2 measurement) and the image point 601 is representative of the collimation error between the two measurement channels. The collimation error, or the vector representative of this collimation error, may include a vertical component ΔV_{A} and a horizontal component ΔH_{A}, as shown in FIG. 6. The position (or the coordinates) of the image point 601 may be obtained by calculating a centre of gravity of the pixels corresponding to (the image of) the collimated calibrating light beam in the captured image.

Assuming that the measurement channel associated with the camera 512 is calibrated relative to the sighting axis (for example using a procedure such as described above with reference to FIGS. 1C, 3A and 3B), it is then possible to determine the absolute collimation error, i.e., the collimation error relative to the sighting axis of the total station, for the measurement channel associated with the EDM unit 514 based on the determined relative collimation error. The same determination can be made for the other measurement channels to which the image points 602 and 603 correspond.

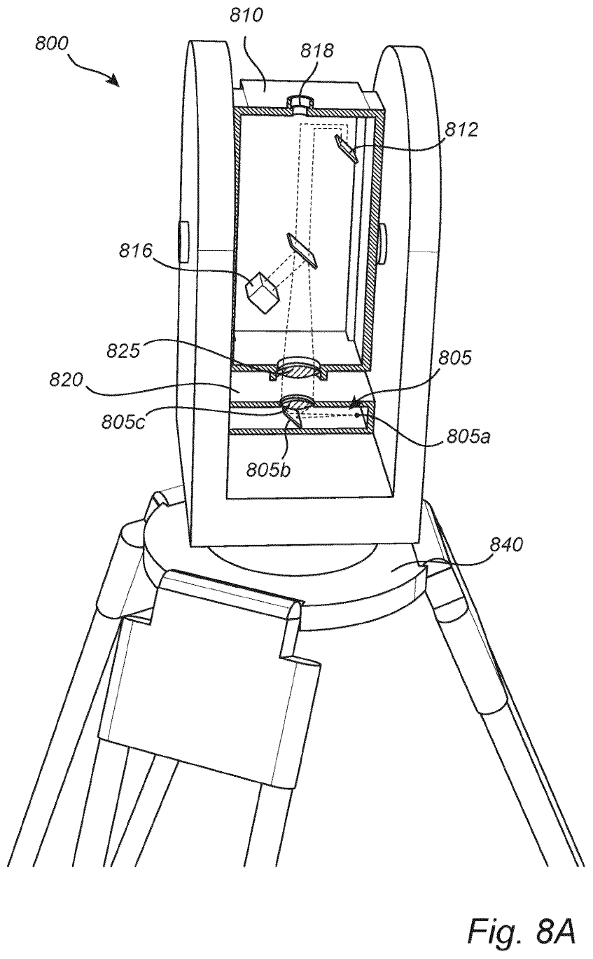

FIG. 7 illustrates the general outlines of a method 7000 of calibrating a total station such as any of the total stations described herein (such as with reference to the preceding and following figures).

At 7100, a collimation error relative to the sighting axis of the total station is determined for any one of the plurality of measurement channels of the total station, thereby providing a calibrated reference measurement channel. This collimation error may be determined by any procedure and, by way of example, by the procedure using a measurement in a first face and a second face such as described above with reference to FIGS. 1C, 3A, 3B and 4.

At 7200, the centre unit of the total station is rotated around at least the first axis to a predetermined position at which a collimated calibrating light beam enters the centre unit via the objective of the centre unit for further propagation towards the camera. This corresponds to the procedure shown in for example FIG. 5A, wherein the centre unit is rotated to be orientated downwards.

The collimated calibrating light beam may then be related to either (i) at least one measurement channel to be calibrated if the calibrated reference measurement channel is the measurement channel associated with the camera or (ii) the calibrated reference measurement channel if the calibrated reference measurement channel is a measurement channel other than the measurement channel associated with the camera. Referring for example to FIG. 5A, this means that the measurement channel associated with the EDM unit 514 may correspond to the calibrated reference measurement channel (and in this case the measurement channel associated with the camera is the measurement channel to be calibrated) or that it may be the measurement channel to be calibrated relative to the measurement channel associated with the camera (and in this case the measurement channel associated with the camera is the calibrated reference measurement channel).

At 7300, at least one image is captured with the camera, wherein the collimated calibrating light beam is detectable in the image, such as shown in, e.g., FIG. 6.

At 7400, a relative collimation error is determined between the measurement channel associated with the camera and the other measurement channel based at least on a position of an image point corresponding to the collimated calibrating beam in the captured image(s), as also illustrated in FIG. 6. As mentioned above, the other measurement channel may either be the measurement channel to be calibrated (if the calibrated reference measurement channel is the measurement channel associated with the camera) or the calibrated reference measurement channel (if the calibrated reference channel is a measurement channel other than the measurement channel associated with the camera).

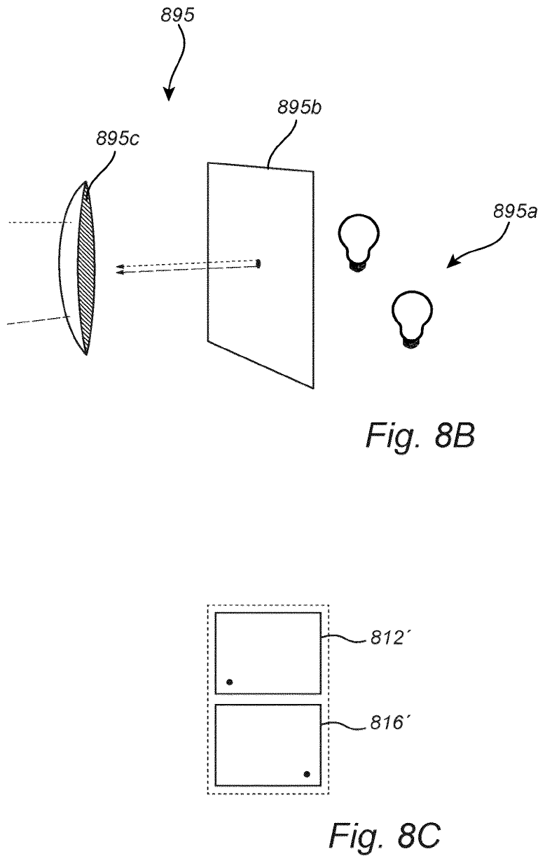

FIG. 8A illustrates the determination of a relative collimation error between a measurement channel associated with a first camera and a measurement channel associated with a second camera using an external light source.

The total station 800 is equivalent to any of the total stations described above with reference to the preceding figures except that in the present embodiment, the total station is equipped with an optical element 805 including a light source for providing a collimated calibrating light beam 806 that enters the centre unit via the front lens 825 of the centre unit 810 when the centre unit 810 is rotated in the predetermined position.

As shown in FIG. 8A, the collimated calibrating light beam may be provided by means of an optical element 805 including a light source 805a emitting light which is reflected against a splitter or mirror 805b and passes a collimating lens 805c before reaching the objective or front lens 825 of the total station 800. The optical element 805 may be placed in the alidade 820 of the total station 800.

Alternatively, as shown in FIG. 8B, the collimated calibrating light beam may be provided by means of an optical element 895 including two light sources 895a placed behind a pinhole or diffuser (or negative crosshair) 895b. Each of the light sources 895a may emit light at a specific wavelength. The optical element 895 may for example include a plate 895b having a small opening such that a divergent beam of light is formed downstream of the pinhole. The beam may then be collimated by a lens 895c of the optical element 895. The optical element 895 may in this case act as a collimator 895 for the calibrating light beam.

All other elements of the total station 800 are equivalent to the elements described above with reference to the total station shown in the preceding figures. This includes for example the first camera 812, the reticle (or eyepiece) 818 and the second camera 816 arranged in the centre unit 810 of the total station 800. The alidade 820 is also mounted on a base 840 and a tripod, as shown in, e.g., FIGS. 1A and 1B.

Further, the collimated light beam may include light of a first wavelength, such as for example visible light, to which the first camera 812 is sensitive and light of a second wavelength, such as for example light at a wavelength of about 800-900 (e.g., 850 nm), to which the second camera 816 is sensitive. From the perspective of the first and second cameras 812 and 816, the collimated calibrating light beam originates from the same optical position, as provided by the optical elements 805 and 895 shown in FIGS. 8A and 8B.

Generally, the first camera 812 may be configured to capture images within a first wavelength range and the second camera 816 may be configured to capture images within a second wavelength range.

As in the previous embodiments, the measurement channel associated with the second camera 816 may be the measurement channel to be calibrated if the calibrated reference measurement channel is the measurement channel associated with the first camera 812, or the calibrated reference measurement channel (in which case other measurement channels, including the measurement channel associated with the first camera, can be calibrated to).

Still referring to FIG. 8A, at least one image 816′ of the collimated calibrating light beam is captured with the second camera 816 and at least one image 812′ of the collimated calibrating light beam is captured with the first camera 812, wherein the collimated calibrating light beam is detectable in such images. A possible example of such images is shown in FIG. 8C.

A relative collimation error between the measurement channel associated with the first camera 812 and the measurement channel associated with the second camera 816 may then be determined based on a comparison between the position of the image point corresponding to the collimated calibrating light beam in an image captured by the first camera 812 and a position of an image point corresponding to the collimated calibrating light beam in an image captured by the second camera 816. This is illustrated by the two images shown in FIG. 8C wherein the collimated calibrating light beam produce image points (or spots) at different positions in the images captured by the first camera and the second camera.

The same procedure may be used even if the first camera and the second camera would be sensitive to the same wavelength range and even if the first wavelength is the same as the second wavelength, as long as the collimated calibrating light beam at this particular wavelength can be detected by both the first camera 812 and the second camera 816.

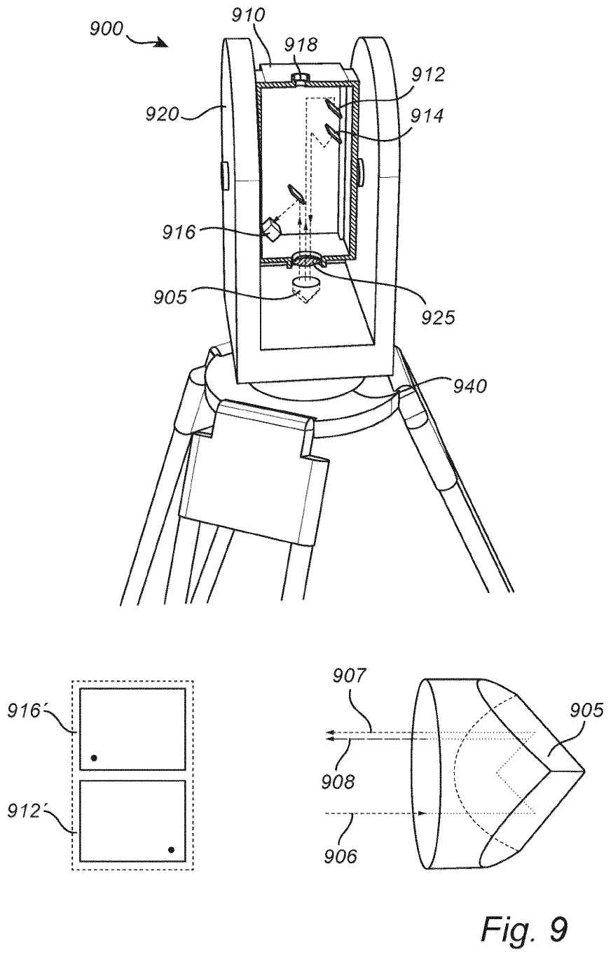

With reference to FIG. 9, another embodiment for obtaining a relative collimation error between measurement channels associated with two different cameras is described.

FIG. 9 shows a situation which is similar to what is shown in FIG. 8A except that the collimated light beam does not originate from an optical element (or light source) that is arranged at the alidade 920 of the total station 900 but from a light source of a measuring device of the plurality of measuring devices of the centre unit 910. In the present example, the light source of the EDM unit 914 may be used to emit a calibrating light beam towards the front lens 925 of the centre unit 910 of the total station 900, thereby becoming a collimated calibrating light beam. The alidade 920 may then be equipped with an optical element 905, such as a retroflector (for example as described with reference to FIG. 5B), at which the calibrating light beam originating from the EDM unit 914 (and being collimated by the front lens 925 when exiting the centre unit) is reflected to re-enter the centre unit 920 via the front lens 925 for further propagation towards the first camera 912 and the second camera 916. It will be appreciated that, as mentioned above, the optical element or retroreflector 905 is positioned at either the alidade 920 or the base 940 of the total station such that it is positioned in front of the front lens or objective 925 when the centre unit 920 is rotated at the predetermined position at which calibration is to be performed.

With respect to the present embodiment, the collimated light beam originating from the EDM unit 914 (or a laser pointer) is detectable at both a first camera 912 sensitive to visible light and a second camera 916 sensitive in the range of, e.g., 800-900 nm. Hence, in the present embodiment, it is possible to calibrate both the measurement channel associated with the second camera 916 relative to the measurement channel associated with the first camera 912 and the measurement channel associated with the EDM unit relative to the measurement channel associated with the second camera 916 (or relative to the measurement channel associated with the first camera 912).

FIG. 9 also shows that the position of the collimated calibrating light beam in a first image 912′ captured by the first camera 912 may deviate from the position of the collimated calibrating light beam in a second image 916′ captured by the second camera 916, thereby indicating the presence of a collimation error between the measurement channel associated with the first camera 912 and the measurement channel associated with the second camera 916. FIG. 9 also provides a closer view of the retroreflector 905 arranged at (or attached to) the alidade 920 of the total station 900 with an incoming light beam 906 received from the EDM unit 914 and a light beam 907, 908 reflected back to the objective 925 of the centre unit 910 of the total station 900 for further propagation towards the first camera 912 and the second camera 916, respectively.

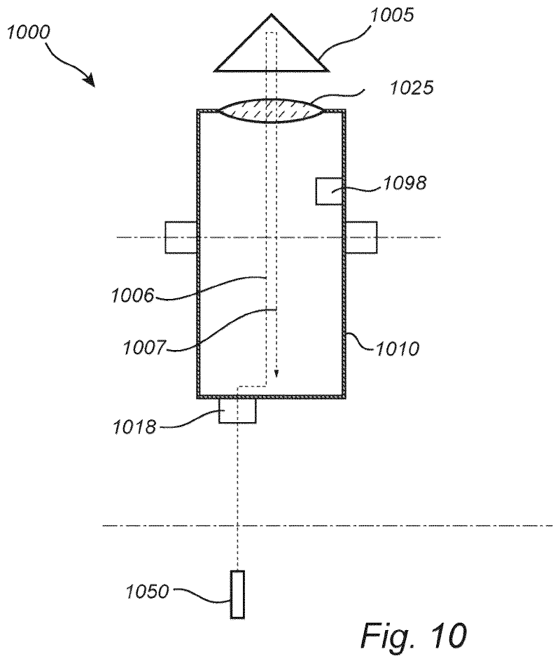

With reference to FIG. 10, the determination of a relative collimation error between a measurement channel associated with a first camera and a measurement channel associated with a reticle of the centre unit of the total station is described.

The principle is generally similar to the principle described above with reference to the preceding figures for the calibration of the other measurement channels except that, in this case, the collimated calibrating light beam that enters the objective (or front lens) 1025 does not originate from a light source placed in front of the objective 1025 of the centre unit 1010 or from a light source located inside the centre unit 1010 but from a light source emitting a light beam entering the centre unit 1010 via the eyepiece 1018 of the centre unit 1010 of the total station 1000. Such a light beam 1006 may then propagate within the centre unit 1010 to become collimated (by the optics of the centre unit 1010), exit the objective 1025 and then be reflected at an optical element 1005, such as a retroreflector, attached, e.g., to the alidade of the total station before entering again the centre unit 1010 as a collimated light beam 1007.

It will be appreciated that the light emitted from the external light source 1050 does not need to be collimated. The light source may for example be a light source provided at a protective bag or protective housing of the total station. As another alternative, the light source may be provided at a handle of the alidade.

Further, it will be appreciated that, for the determination of a relative collimation error between a measurement channel associated with the camera or another camera, as an alternative to what has been described with reference to the preceding figures, the initial light beam may also originate from a light source external to the total station (or external to the centre unit) such that the initial light beam enters the centre unit via the eyepiece of the centre unit. Still, as described above, the collimated light beam is redirected towards the camera by re-entering the centre unit via the objective of the centre unit and via retroreflection against an optical element, such as a retroreflector.

It will also be appreciated that, although the present disclosure provide embodiments in which the relative collimation errors can be determined for several measurement channels when the centre unit is rotated to a single predetermined position and using a single collimated calibrating light beam, it is also possible that the centre unit is rotated to different predetermined positions. Further, it is also possible that multiple collimated calibrating light beams are used.

For example, after having determined the relative collimation error between a first measurement channel and the measurement channel associated with the camera when the centre unit is rotated to a first predetermined position, a relative collimation error may be determined between a measurement channel associated with another measuring device and the measurement channel associated with the camera by rotating the centre unit around at least the first axis to another predetermined position at which another collimated calibrating light beam enters the centre unit via the objective for further propagation towards the camera. This other collimated calibrating light beam may then be related to the measurement channel associated with this other measuring device. A relative collimation error may then be determined between the measurement channel associated with the camera and the measurement channel associated with this other measuring device based at least on a position of an image point corresponding to this other collimated calibrating beam in an additional image captured by the camera.

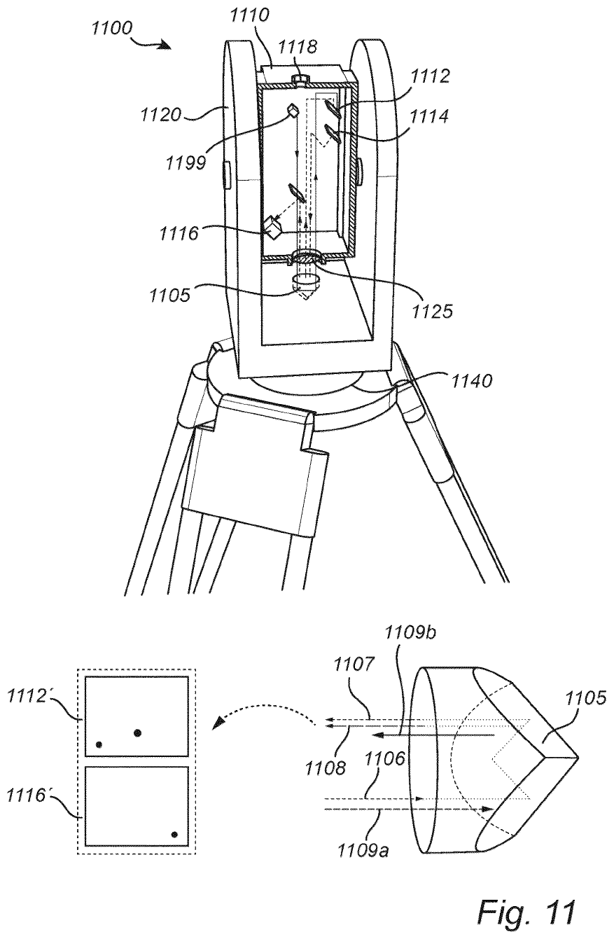

With reference to FIG. 11, another embodiment in which a plurality of collimated light beams are used in a single predetermined position is described.

FIG. 11 shows a total station 1100 which is equivalent to the total station 900 (and scenario) described with reference to FIG. 9 except that, instead of having only one calibrating light beam originating 1106 from the EDM unit 1114 (corresponding to the beam 906 of the EDM unit 914 in FIG. 9) impinging on the retroreflector 1105 (corresponding to the retroreflector 905 in FIG. 9), an additional calibrating light beam 1109a originates from another device such as, for example, a laser pointer 1199.

As shown in FIG. 11, in the present example, the light source of the laser pointer 1199 may be used to emit an additional calibrating light beam towards the front lens 1125 of the centre unit 1110 of the total station 1100. The alidade 1120 may then be equipped with an optical element 1105, such as a retroflector (for example as described with reference to FIG. 5B), at which the calibrating light beam originating from the laser pointer 1199 is reflected to re-enter the centre unit 1120 via the front lens 1125 for further propagation towards the first camera 1112. It will be appreciated that, as mentioned above, the optical element or retroreflector 1105 is positioned at either the alidade 1120 or the base 1140 of the total station such that it is positioned in front of the front lens or objective 1125 when the centre unit 1120 is rotated at the predetermined position at which calibration is to be performed.

In the present embodiment, a first calibrating light beam 1106 is emitted from the EDM unit 1114 and is detected at the first camera 1112 and the second camera 1116, thereby enabling the relative calibration of the collimation error between the measurement channels associated with the EDM unit 1114, the first camera 1112 and the second camera 1116. Images 1112′ and 1116′ captured by the first and second cameras, respectively, illustrate that the first calibrating light beam is detectable in both images. In addition, the second calibrating light 1109a emitted from the laser pointer 1199 and detected at the first camera 1112 enable the relative calibration of the collimation error between the measurement channels associated with the laser pointer 1199, the first camera 1112 and the EDM unit 1114 since both the first and second calibrating light beams 906 and 1109a, being reflected at the optical element 1105 as light beams 1107 and 1109b are detectable in an image 1112′ captured by the first camera 1112. Hence, it is then possible to determine the collimation error associated with each one of these measurement channels relative to the sighting axis of the total station if the (absolute) collimation error relative to the sighting axis is known for at least one of these measurement channels.

For this purpose, the total station may then include a first optical element attached to the alidade or the base for providing a first collimated calibrating light beam with the centre unit rotated in a first predetermined position and a second optical element attached to the alidade or the base for providing a second collimated calibrating light beam with the centre unit rotated in a second predetermined position.

Further, it will be appreciated that at least the determination of the relative collimation error between two measurement channels of the total station may be automatic in that a processing unit, such as for example the processing unit 1098 schematically illustrated in FIG. 10, is configured to determine, or obtain, a collimation error relative to the sighting axis of the total station for any one of the plurality of measurement channels and then cause the rotation of the centre unit around at least the first axis to a predetermined position at which a collimated calibrating light beam emitted at, or reflected against, the optical element attached to the alidade or the base, enters the centre unit for further propagation towards the camera. The control unit may also be configured to cause the capture of an image with the camera and to determine the relative collimation error between a measurement channel associated with the camera and another measurement channel associated with an other measuring device than the camera.

It will be appreciated that, unless explicitly stated otherwise, the examples shown in different figures may be combined, and elements having like reference numerals in different figures may be the same or similar to each other. In any event, it is intended that the foregoing description not to be limiting upon the scope of the invention, and that the invention be defined only by the scope of the following claims.

1. A method of calibrating a total station comprising a centre unit mounted on an alidade for rotation about a first axis, wherein the alidade is mounted on a base of the total station for rotation about a second axis orthogonal to the first axis such that a sighting axis of the total station is rotatable about a rotation point, wherein the centre unit includes a plurality of measuring devices, wherein each measuring device of the plurality of measuring devices has an optical axis, wherein at least one measuring device of the plurality of measuring devices is a camera configured to capture images, wherein the centre unit includes a plurality of measurement channels, wherein each measurement channel is associated with a measuring device of the plurality of measuring devices, said method comprising:
determining a collimation error relative to said sighting axis for any one of the plurality of measurement channels, thereby providing a calibrated reference measurement channel;
rotating the centre unit around at least said first axis to a predetermined position at which a collimated calibrating light beam enters the centre unit via an objective of the centre unit for further propagation towards said camera, wherein said collimated calibrating light beam is related to (i) at least one measurement channel to be calibrated if the calibrated reference measurement channel is the measurement channel associated with the camera or (ii) said calibrated reference measurement channel if the calibrated reference measurement channel is a measurement channel other than the measurement channel associated with the camera;
capturing at least one image with said camera, wherein said collimated calibrating light beam is detectable in said at least one image; and
determining a relative collimation error between the measurement channel associated with the camera and said at least one measurement channel to be calibrated if the calibrated reference measurement channel is the measurement channel associated with the camera, or between the measurement channel associated with the camera and the calibrated reference measurement channel if the calibrated reference channel is a measurement channel other than the measurement channel associated with the camera, based at least on a position of an image point corresponding to said collimated calibrating beam in said at least one captured image.

2. The method according to claim 1, wherein the determination of the collimation error of the reference measurement channel relative to the sighting axis of the total station includes sighting the centre unit towards a far-field object.

3. The method according to claim 1, wherein the determination of the collimation error of the reference measurement channel relative to the sighting axis of the total station includes performing a first measurement in a first face of the total station and a second measurement in a second face of the total station, wherein, in the second face, the centre unit is rotated around each one of the first axis and the second axis of the total station by 180° compared to the first face.

4. The method according to claim 1, wherein the camera is either one of a camera configured for capturing images of a scene surrounding said total station or a camera configured for tracking of a target by said total station.

5. The method according to claim 1, wherein said at least one measurement channel to be calibrated if the calibrated reference measurement channel is the measurement channel associated with the camera, or the calibrated reference measurement channel if the calibrated reference measurement channel is a measurement channel other than the measurement channel associated with the camera, includes a measurement channel associated with a measuring device including a light source, and wherein the collimated calibrating light beam originates from said light source and enters the centre unit by retroreflection against an optical element attached to said alidade or said base of the total station.

6. The method according to claim 5, wherein the measuring device including the light source is one of a laser pointer or an electronic distance measurement device.

7. The method according to claim 1, wherein said camera is a first camera configured to capture images within a first wavelength range and wherein said at least one measurement channel to be calibrated if the calibrated reference measurement channel is the measurement channel associated with the first camera, or the calibrated reference measurement channel if the calibrated reference measurement channel is a measurement channel other than the measurement channel associated with the first camera, includes a measurement channel associated with a second camera configured to capture images within a second wavelength range, wherein the collimated calibrating light beam includes light of a first wavelength within said first wavelength range and light of a second wavelength within said second wavelength range,
wherein said method further comprises:
capturing at least one image of said collimated calibrating light beam with said second camera, wherein said collimated calibrating light beam is detectable in said at least one image, and
wherein said determining a relative collimation error includes a comparison between the position of the image point corresponding to the collimated calibrating light beam in said at least one image captured by the first camera and a position of an image point corresponding to the collimated calibrating light beam in said at least one image captured by the second camera.

8. The method according to claim 7, wherein the first wavelength is the same as the second wavelength.

9. The method according to claim 7, wherein the first wavelength range is the same as the second wavelength range.

10. The method according to claim 7, wherein the collimated calibrating light beam originates from a light source of a measuring device of said plurality of measuring devices and enters the centre unit by retroreflection against an optical element attached to said alidade or said base of the total station, or
wherein the collimated calibrating light beam originates from a light beam entering the centre unit via an eyepiece of said total station and propagating towards an optical element attached to said alidade or said base of the total station before entering again the centre unit by retroreflection against said optical element.

11. The method according to claim 7, wherein the first wavelength is different from the second wavelength and/or wherein the first wavelength is in the visible wavelength range and the second wavelength is in the range of 800-900 nm.

12. The method according to claim 7, wherein the collimated calibrating light beam originates from a light source attached to said alidade or said base of the total station; or
wherein the collimated calibrating light beam originates from a light beam entering the centre unit via an eyepiece of said total station and propagating towards an optical element attached to said alidade or said base of the total station before entering again the centre unit by retroreflection against said optical element.

13. The method according to claim 1, wherein said at least one measurement channel to be calibrated if the calibrated reference measurement channel is the measurement channel associated with the camera, or the calibrated reference measurement channel if the calibrated reference measurement channel is a measurement channel other than the measurement channel associated with the camera, includes a measurement channel associated with a reticle of the centre unit of said total station, and wherein the collimated calibrating light beam originates from a light beam entering the centre unit via the measurement channel associated with the reticle of the centre unit of said total station and propagating towards an optical element attached to said alidade or said base of the total station before entering again the centre unit by retroreflection against said optical element.

14. The method according to claim 13, wherein the light beam entering the centre unit via the channel associated with the reticle of the centre unit of said total station is not collimated.

15. The method according to claim 1, further comprising performing a relative calibration between a measurement channel associated with another measuring device and the measurement channel associated with the camera by:
rotating the centre unit around at least said first axis to another predetermined position at which another collimated calibrating light beam enters the centre unit via the objective of the centre unit for further propagation towards said camera, wherein said another collimated calibrating light beam is related to said measurement channel associated with said another measuring device;
capturing at least one additional image with said camera, wherein said another collimated calibrating light beam is detectable in said at least one additional image; and
determining a relative collimation error between the measurement channel associated with the camera and the measurement channel associated with said another measuring device based at least on a position of an image point corresponding to said another collimated calibrating beam in said at least one additional image.

16. (canceled)

17. A total station comprising:
a centre unit mounted on an alidade for rotation about a first axis,
a base on which the alidade is mounted for rotation about a second axis intersecting the first axis such that a sighting axis of the total station is rotatable about a rotation point,
wherein the centre unit includes a plurality of measuring devices, wherein each measuring device of the plurality of measuring devices has an optical axis, wherein at least one measuring device of the plurality of measuring devices is a camera configured to capture images,
wherein the centre unit includes a plurality of measurement channels, wherein each measurement channel is associated with a measuring device of the plurality of measuring devices,
at least one optical element attached to said alidade or said base, and
a processing unit configured to perform a calibration of said total station by:
determining a collimation error relative to said sighting axis for any one of the plurality of measurement channels, thereby providing a calibrated reference measurement channel;
causing the rotation of the centre unit around at least said first axis to a predetermined position at which a collimated calibrating light beam emitted at, reflected against, said optical element enters the centre unit via an objective of the centre unit for further propagation towards said camera, wherein said collimated calibrating light beam is related to (i) at least one measurement channel to be calibrated if the calibrated reference measurement channel is the measurement channel associated with the camera or (ii) said calibrated reference measurement channel if the calibrated reference measurement channel is a measurement channel other than the measurement channel associated with the camera;
causing the capture of at least one image with said camera, wherein said collimated calibrating light beam is detectable in said at least one image; and
determining a relative collimation error between the measurement channel associated with the camera and said at least one measurement channel to be calibrated if the calibrated reference measurement channel is the measurement channel associated with the camera, or between the measurement channel associated with the camera and the calibrated reference measurement channel if the calibrated reference channel is a measurement channel other than the measurement channel associated with the camera, based at least on a position of an image point corresponding to said collimated calibrating beam in said at least one captured image.

18. The total station of claim 17, wherein the processing unit is configured to perform a method comprising:
determining a collimation error relative to said sighting axis for any one of the plurality of measurement channels, thereby providing a calibrated reference measurement channel;
rotating the centre unit around at least said first axis to a predetermined position at which a collimated calibrating light beam enters the centre unit via an objective of the centre unit for further propagation towards said camera, wherein said collimated calibrating light beam is related to (i) at least one measurement channel to be calibrated if the calibrated reference measurement channel is the measurement channel associated with the camera or (ii) said calibrated reference measurement channel if the calibrated reference measurement channel is a measurement channel other than the measurement channel associated with the camera;
capturing at least one image with said camera, wherein said collimated calibrating light beam is detectable in said at least one image; and
determining a relative collimation error between the measurement channel associated with the camera and said at least one measurement channel to be calibrated if the calibrated reference measurement channel is the measurement channel associated with the camera, or between the measurement channel associated with the camera and the calibrated reference measurement channel if the calibrated reference channel is a measurement channel other than the measurement channel associated with the camera, based at least on a position of an image point corresponding to said collimated calibrating beam in said at least one captured image.

19. The total station of claim 17, wherein said at least one optical element includes at least one of a retroreflector against which light emitted from a light source of a measuring device of the plurality of measuring devices is reflected with the centre unit rotated in a first predetermined position and a light source for emission of a collimated calibrating light beam having a first wavelength and a second wavelength.
